(19) United States
(12) Patent Application Publication
(10) Pub. No.: US 2005/0060741 A1
(43) Pub. Date: Mar. 17, 2005

(54) Media data audio-visual device and metadata sharing system

(75) Inventors: Hideki Tsutsui, Kanagawa-ken (JP); Toshihiko Manabe, Kanagawa-ken (JP); Masaru Suzuki, Kanagawa-ken (JP); Tomoko Murakami, Kanagawa-ken (JP); Shozo Isobe, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/730,930

(22) Filed: Dec. 10, 2003

(30) Foreign Application Priority Data
Dec. 10, 2002 (JP) 2002-358216

(51) Int. Cl. H04N 7/025; G06F 3/00; H04N 5/445; G06F 13/00; H04N 7/16

(52) U.S. Cl. 725/32; 725/135; 725/136; 725/53

(57) ABSTRACT

A system and device for sharing metadata that includes a plurality of client media data audio-visual devices and a server. Each of the plurality of client media data audio-visual devices is configured to display media data and metadata corresponding to the media data. The server is configured to exchange data among the plurality of client media data audio-visual devices. Each of the plurality of client media data audio-visual devices includes an audio-visual portion, a metadata storing portion, a communication portion, and a display portion. The audio-visual portion is configured to display the media data. The metadata storing portion is configured to store the metadata. The communication portion is configured to transmit the metadata to the server and to receive metadata from the server to be stored in the metadata storing portion. The display portion is configured to display a time relationship between the media data and the metadata based on time data included in the metadata and in the media data. The server includes a metadata storing portion configured to store the metadata transmitted from the plurality of client media data audio-visual devices.

### CROSS-REFERENCE TO RELATED APPLICATIONS

The present application claims priority under 35 USC §119 to Japanese Patent Application No. 2002-358216 filed on Dec. 10, 2003, the entire contents of which are herein incorporated by reference.

### BACKGROUND OF THE INVENTION

1. Field of the Invention

The present invention relates to media data audio-visual devices, and more specifically to media data audio-visual devices capable of creating, obtaining and displaying metadata associated with media data. The present invention also relates to a metadata sharing system capable of sharing metadata among a plurality of viewers of media data.

2. Discussion of the Background

In recent years, in order to facilitate access to media data, especially streaming media data (e.g., TV programs, movies supplied by DVDs, etc.), there has been an attempt to add metadata to media data using coding formats such as MPEG-7.

In the present context, metadata (“data about data”) is information associated with media data that describes the content, quality, condition or other characteristics of the media data. For instance, metadata can be used to describe a broadcast station that broadcasted the media data, a broadcasting date and time of the media data, and content parameters of the media data to which the metadata is associated. Metadata can be used to search a large amount of media data for a desired piece of information or characteristics. Further, the use of metadata also makes it possible to selectively watch specific scenes or portions of media data. For instance, specific scenes or portions showing a player “B” of baseball team “A” during the broadcasting of a baseball game may be selected and searched if metadata is associated in advance with the media data indicating the scenes or portions where player “A” appears in the program.

MPEG-7 is an ISO/IEC standard developed by MPEG(Moving Picture Experts Group) used to describe the multimedia content data that will support interpretation of the information's meaning, which can be passed onto, or accessed by, a device or a computer code.

An audio-visual device capable of searching predetermined media data using metadata is generally known, such as disclosed by Japanese Patent Publication No. P2001-306581A. This media data audio-visual device includes a media data storing portion, a metadata storing portion, a media data management portion, a metadata management portion and an inquiry portion that searches the media data portion and the metadata portion. Predetermined media data can be searched efficiently from an application program via the inquiry portion. Further, metadata is dynamically created in accordance with access to stored metadata, and audio-visual data access history information is converted into metadata and exchanged between the media audio-visual device and another media audio-visual device.

Metadata can exist in many different forms. For instance, metadata may be embedded together with media data by the media data creators in advance (e.g., motion picture scene segment information provided with a DVD). Metadata may also be created in accordance with a viewer's viewing history and stored in a media data audio-video device. Further, metadata may be actively created by a viewer (e.g., a viewer's impressions of a movie, a viewer's comments on a favorite scene thereof.

Metadata that is created by a viewer is often of great informational value for other viewers. Thus, it would be very convenient and advantageous if such metadata could be exchanged between viewers and utilized to search or edit media data.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

It is an object of the present invention to provide a media data audio-visual device for viewing media data that includes an audio-visual portion, a metadata storing portion, a communication portion, and a display portion. The audio-visual portion is configured to display the media data. The metadata storing portion is configured to store metadata corresponding to the media data. The communication portion is configured to transmit the metadata externally and receives external metadata to be stored in the metadata storing portion. The display portion is configured to display a time relationship between selected media data and selected metadata based on time data embedded in the media data and in the metadata.

It is another object of the present invention to provide a metadata sharing system that includes a plurality of client media data audio-visual devices and a server. Each of the plurality of client media data audio-visual devices is configured to display media data and metadata corresponding to the media data. The server is configured to exchange data among the plurality of client media data audio-visual devices. Each of the plurality of client media data audio-visual devices includes an audio-visual portion, a metadata storing portion, a communication portion, and a display portion. The audio-visual portion is configured to display the media data. The metadata storing portion is configured to store the metadata. The communication portion is configured to transmit the metadata to the server and to receive metadata from the server to be stored in the metadata storing portion. The display portion is configured to display a time relationship between the media data and the metadata based on time data included in the metadata and in the media data. The server includes a metadata storing portion configured to store the metadata transmitted from the plurality of client media data audio-visual devices.

It is yet another object of the present invention to provide a metadata sharing system that includes a plurality of client media data audio-visual devices and a server. Each of the plurality of client media data audio-visual devices is configured to display media data and metadata. The server is configured to exchange data among the plurality of client media data audio-visual devices. Each of the plurality of client media data audio-visual devices includes an audio-visual portion, a metadata creating portion, a metadata storing portion, and a communication portion. The audio-visual portion is configured to display the media data. The metadata creating portion is configured to enable a user to create metadata corresponding to the media data. The metadata storing portion is configured to store the metadata. The communication portion is configured to transmit the metadata created by the metadata creating portion to the server and to receive metadata from the server to be stored in the metadata storing portion. The server includes a metadata storing portion configured to store the metadata transmitted from each of the plurality of client media data audio-visual devices and a bulletin board configured such that created messages may be posted by the plurality of client media data audio-visual devices. The metadata creating portion associates created messages with a specified position in corresponding media data. The communication portion is configured to transmit the created messages to the server and the created messages are written to a bulletin board corresponding to the specified position.

It is still another object of the present invention to provide a metadata sharing system that includes a plurality of client media data audio-visual devices and a server. Each of the plurality of client media data audio-visual devices is configured to display media data and metadata. The server is configured to exchange data among the plurality of client media data audio-visual devices. The server includes scrambled media data and associated metadata containing descrambling information for the scrambled media data to allow the scrambled media data to be viewed on at least one of the plurality of client media data audio-visual devices. Each of the plurality of client media data audio-visual devices includes an audio-visual portion, a metadata creating portion, a metadata storing portion, a communication portion, and a descrambling portion. The audio-visual portion is configured to display media data. The metadata creating portion is configured to enable a user to create metadata corresponding to specific media data. The metadata storing portion is configured to store metadata. The communication portion is configured to transmit metadata created by the metadata creating portion to the server and to receive the media data and the metadata form the server. The descrambling portion is configured to descramble the scrambled media data received from the server using the descrambling information contained in the metadata received from the server.

Other objects and features of the invention will be apparent from the following detailed description with reference to the attached drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a block diagram showing a structure of a media audio-visual device according to an embodiment of the present invention;

FIG. 1B is a block diagram showing a structure of a metadata sharing system according to an embodiment of the present invention;

FIG. 2 is an example of metadata;

FIG. 3 is another example of metadata;

FIG. 4 shows the details of the metadata creating portion of FIGS. 1A and 1B;

FIG. 5 shows an example of a display screen for sending a metadata search request;

FIG. 6 shows an example of a search result display screen showing metadata search results;,

FIG. 7 is a schematic illustration of a method for performing synchronization of media data and metadata based on correlation of the feature amount of the image in the media data with corresponding data contained in the metadata;

FIG. 8 is a schematic illustration of another method for performing synchronization of media data and metadata;

FIG. 9 shows an example of a display screen having media data and metadata displayed simultaneously after synchronization;

FIG. 10 shows an example of a display screen displaying metadata search results;

FIG. 11 is a block diagram showing the media data audio-visual device according to an alternate embodiment of the present invention;

FIG. 12 is an example of a display screen displaying matched media data and bulletin board data;

FIG. 13 is a schematic illustration of another display method for bulletin board data;

FIG. 14 shows a screen displaying search results in the metadata sharing system according to an alternate embodiment of the present invention;

FIG. 15 is a block diagram showing a metadata sharing system according to an alternate embodiment of the present invention; and

FIG. 16 shows another structure of a metadata sharing system according to an embodiment of the present invention.

### DETAILED DESCRIPTION OF THE PREFERRED EMBODIMENTS

Referring now to the drawings, wherein like reference numerals designate identical or corresponding parts throughout the several views.

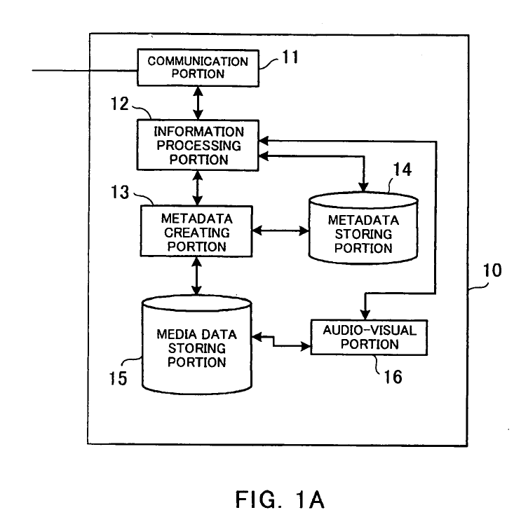

Referring to FIG. 1A, a block diagram showing a structure of a media data audio-visual device according to an embodiment of the present invention is shown. In this embodiment, the media data audio-visual device 10 includes a communication portion 11, an information processing portion 12, a metadata creating portion 13, a metadata storing portion 14, a media data storing portion 15, and an audio-visual portion 16. As shown in FIG. 1B, the media data audio-visual device 10-1 is connected to other media data audio-visual devices (10-1, . . . , 10-n) via a network 51. The media data audio-visual devices (10-1, . . . , 10-n) function as clients of the client-server system, and constitute a metadata sharing system together with a server 20. Each media data audio-visual device (10-1, . . . , 10-n) can disclose its self-created metadata to another media data audio-visual device (10-1, . . . , 10-n) by receiving the metadata via the server 20.

The server 20 includes a communication portion 21, an information processing portion 22 and a metadata storing portion 23.

The following explanation is directed to structural elements of the media data audio-visual device (10-1, . . . , 10-n) and the server 20. Each of the communication portions 11 of the media data audio-visual devices (10-1, . . . , 10-n) exchanges metadata with the communication portion 21 of the server 20 via the network 51. The metadata transmitted from the communication portion 11 is stored in the metadata storing portion 23 via the information processing portion 22. In response to a request from each media data audio-visual device (10-1, . . . , 10-n), the metadata stored in the metadata storing portion 23 will be outputted to the requesting media data audio-visual device (10-1, . . . , 10-n) by the information processing portion 22 and the communication portion 21.

The information processing portion 12 of the media data audio-visual device 10 controls the data processing of the media data audio-visual device 10. For instance, the information processing portion 12 forwards metadata obtained via the communication portion 11 to the metadata storing portion 14. The information processing portion 12 also subjects the media data stored in the media data storing portion 15 to well-known image processing to thereby obtain, for example, scene segment information or characteristic data of data images based on the image-processed results and then storing the results in the metadata storing portion 14 as metadata. In addition, the information processing portion 12 receives TV broadcast programs via a TV receiver (not shown) and stores the programs in the media data storing portion 15 as media data. The information processing portion 22 in the server 20 controls the communication portion 21 and the reading and writing of the metadata storing portion 23. The information processing portion 22 also stores as a log the history of sending and receiving metadata.

The metadata creating portion 13 may be use to create standard metadata associated with received media data, such as the broadcast time and date, broadcast station, and time duration of the media data. The metadata creating portion 13 also allows a viewer to create metadata corresponding to media data. For instance, the metadata creating portion 13 allows a viewer to create metadata containing the viewer's impression or critique of the media data, or the viewer's comments on specific portions of the media data. A detailed explanation of the operation of the metadata creating portion 13 is provided below.

The metadata storing portion 14 stores metadata such as metadata embedded in media data in advance by a media data creator (e.g., motion picture scene segment information) or metadata created by a user in the metadata creating portion 13. The metadata storing portion 14 can be constituted by a system in which data is expressed by multiple items (e.g., broadcasting station name, broadcasting date, program name) such as a relational database where the data is stored in a table.

The metadata storing portion 23 of the server 20 stores metadata created in each media data audio-visual device (10-1, . . . , 10-n) that is designated for disclosure to other audio-visual devices. When a metadata search request is transmitted from one of the media data audio-visual devices (10-1, . . . , 10-n) on the network 51, the search request is translated into a query language in the information processing portion 22 of the server 20 and the search is then executed in the metadata storing portion 23.

The media data storing portion 15 stores various media data obtained from TV broadcasts or obtained from DVD software. The audio-visual portion 16 allows a user to view and listen to the media data and the metadata.

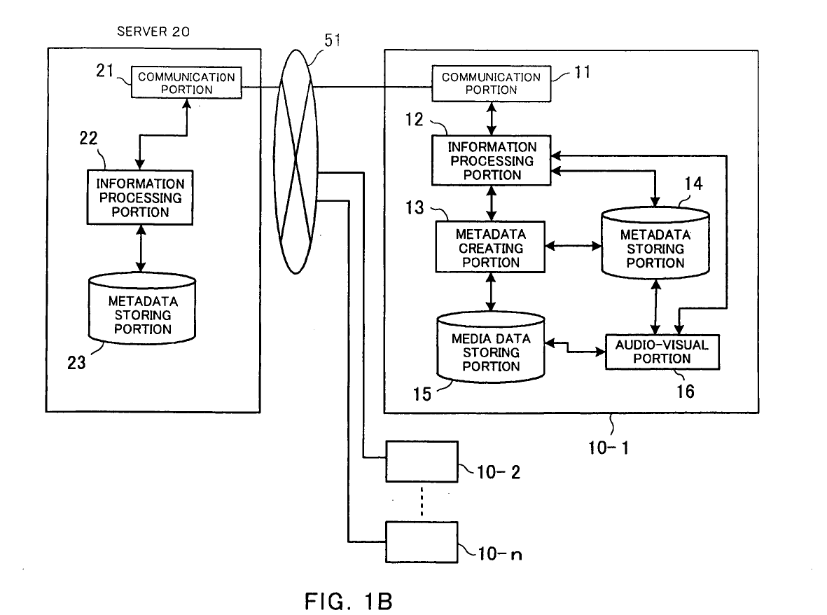

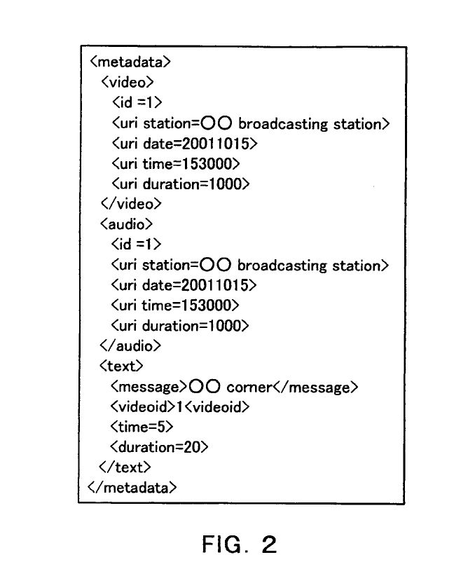

Referring to FIGS. 2 and 3, examples of metadata stored in the metadata storing portion based on MPEG-7 are shown. Metadata are expressed by tags based on XML(eXtensible Markup Language) and its values. In FIG. 2, the portion of the metadata corresponding to video is shown from the “<video>” to “</video>” tags. As shown, the “<id=1>” tag indicates that the image ID is 1. The “<uri station=** broadcasting station>” tag indicates the name of the broadcasting station. The “<uri data=20011015>” tag indicates that the date of the media data is Oct. 15, 2001. The “<uri time=153000>” tag indicates that the media data began broadcast at 3:30:00 PM. The “<uri duration=1000>” tag indicates that the total playing time of the media data is 1,000 seconds.

The portion of the metadata corresponding to audio that accompanies the images is shown from the “<audio>” to “</audio>” tags. As shown, the “<id=1>” tag indicates that the audio ID is “1.” The “<uri station=** broadcasting station>” tag indicates that the name of the broadcasting station. The “<uri data=20011015>” tag indicates the date of the media data is Oct. 15, 2001. The “<uri time=153000>” tag indicates that the media data began broadcast at 3:30:00 PM. The “<uri duration=1000>” denotes that the total playing time of the media data is 1,000 seconds.

The portion of the metadata corresponding to display characters is shown from the “<text>” to “</text>” tags. As shown, the “<message>** corner</message>”, “<videoid>1</videoid>”, “<time=5>” and “<duration=20>” tags indicate that, in video data whose video ID is 1, the characters “** corner” will be displayed for 20 seconds from the position 5 seconds after the beginning of the image data.

An example of metadata in which a plurality of video portions, audio portions, and display characters portions is shown in FIG. 3.

Additional information such as a TV program title and/or an authentication ID of a metadata creator may also be inputted as metadata. For instance, the image ID and audio ID are not inherent in the media data but may be created at the time of creating the metadata in order to discriminate among various stored metadata.

FIGS. 2 and 3 show metadata embedded in media in advance by a media data creator. Metadata created using the metadata creating portion 13 is stored in the metadata storing portion 14 after being converted into an XML expression in the form of a tag and its value in the same manner as shown in FIG. 2 by the information processing portion 12. Additionally, metadata may also be expressed in a binary format such as a binary format for MPEG data(BiM).

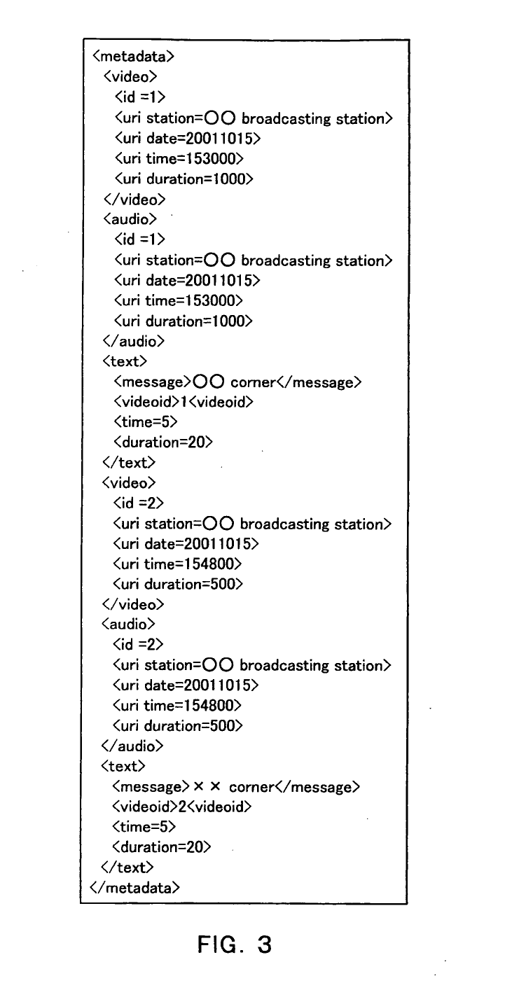

Referring now to FIG. 4, a metadata creating portion 13 is shown with a media data displaying portion 31, an annotation inputting/displaying portion 32, a controlling portion 33, a metadata name displaying portion 34, a time data displaying portion 35 and a time-lines portion 36. The media data displaying portion 31 reproduces the media data stored in the media data storing portion 15. The annotation inputting/displaying portion 32 displays an annotation inputted by a user through a keyboard or other character inputting device (not shown). The annotation inputting/displaying portion 32 is used to add character annotations to the media data that is displayed on the media data displaying portion 31. Characters inputted by a user are displayed on the annotation displaying portion 32A. The user selects the add button 32B to store the inputted annotation text in the metadata storing portion 14 as metadata together with the corresponding time information of the associated media data and the like. The user may select the Disclose box (Pb) to disclose the metadata stored in the metadata storing portion 14 via the network 51. When the Disclose box (Pb) is selected, the metadata is forwarded to the server 20 via the network 51 and is then stored in the metadata storing portion 23.

The controlling portion 33 controls the output of the media data displayed on the media data displaying portion 31. The controlling portion 33 includes a complete rewind button 331, a rewind button 332, a stop button 333, a play button 334, a pause button 335, a forward button 336 and a complete forward button 337. Selecting the play button 334 reproduced the media data in the media data displaying portion 31 at a normal playback speed. Selecting the forward button 336 or the rewind button 332 causes the media data currently being reproduced in the media data displaying portion 31 to be fast-forwarding or fast-rewinding, respectively. Selecting the stop button 333 terminates the playback of the media data in the displaying portion 31. Selecting the pause button 335 displays a current static image of the media of the media data in the displaying portion 31. Selecting the complete rewind button 331 positions the media data to its head portion. Selecting the complete forward button 337 positions the media data to its end portion.

A time-lines portion 36 shows time relationships between media data and metadata. For instance, white portions 361 and 364 of the time-lines portion 36 may indicate time locations in which both media data and metadata exist such as locations in media data with corresponding metadata, or locations in metadata with corresponding media data. Black portion 362 of the time-lines portion 36 may indicate a portion of media data for which no metadata exists. Also, gray portions 365 of the time-lines portion 36 may indicate portions of metadata for which no corresponding media data exists. A time-bar 363 of the time-lines portion 36 indicates the time position for the media data currently being displayed in the display portion 31.

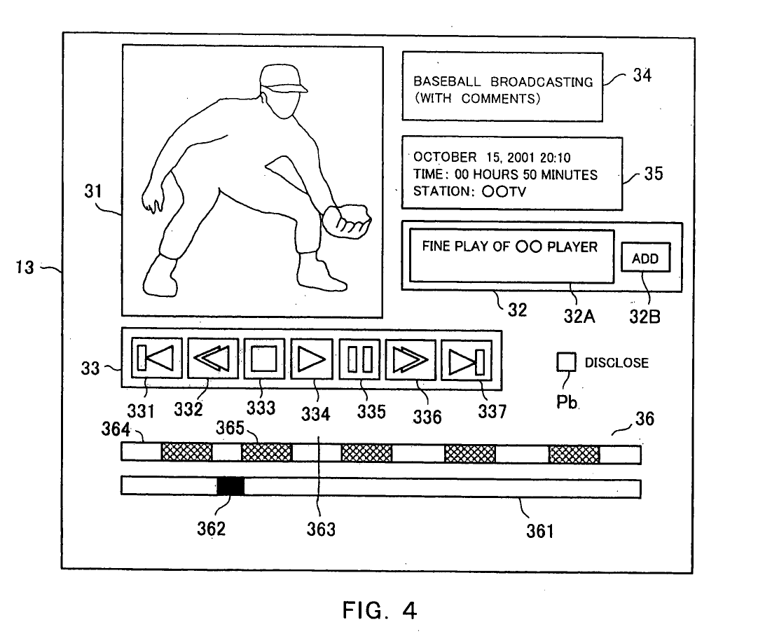

Referring to FIG. 5, a display screen for transmitting a metadata search request to the server 20 is shown. As shown, a list of the media data stored in the media data storing portion 15 are displayed as thumbnail icons, the broadcasting start year/date/time, the total broadcasting duration and the broadcasting station name. For instance, displays of a baseball broadcast media data (MD1), a tennis broadcast media data (MD2), and a football broadcast media data (MD3) each stored in media data storing portion 15 of a particular media data audio-visual device are shown in FIG. 5. A viewer may view a desired media data from among the displayed media data thumbnail icons by selecting the desired media data with a selection tool such as a mouse. A viewer may also transmit a metadata search request regarding the media data to the server 20 by selecting one of the METADATA SEARCH buttons (SB1, SB2 or SB3). Selecting one of the METADATA SEARCH buttons (SB1, SB2 or SB3) creates and then sends to the server 20 a corresponding search request including the search parameters of the media data broadcasting start year/date/time, the total broadcasting duration and the broadcasting station name. Upon receiving the search request, the server 20 searches the metadata storing portion 23 for corresponding metadata stored therein. The server 20 preferably searches for metadata whose time data most overlaps the time data of the search request. Additionally, a metadata search may be initiated using a search character storing manually inputted.

Alternatively, a search request can be performed by inputting only a search character string. Upon receiving the search character string as a search request, the server 20 calculates a correlation between the character string written in a title or comments of the stored metadata and the search character string of the search request to search the stored metadata with a high correlation. For instance, a search character string “commentary of baseball broadcasting” as a search request may result in locating stored metadata with a title of “commentary is added to each play in the baseball broadcasting” from the metadata storing portion 23. The calculation method of the character string correlation may be based on any known language processing technology. For instance, morphological analysis may be carried out for each character string to extract words and express the word sequence as a word vector to be used to calculate an inner product with corresponding vectors from the stored metadata.

Further, a media data time information list showing media data owned by a requesting media data audio-visual device (10-1, . . . , 10-n) may be added to the search request to search for metadata having time data substantially overlapping the media data list. In this way, search efficiency may be improved by excluding from the search target metadata that does not correspond to any media data stored in the media data audio-visual device (10-1, . . . , 10-n). Additionally, the search results of media data owned by the requesting media data audio-visual device (10-1, . . . , 1-n) may be rearranged such that the search results are displayed in order of decreasing overlapping time data.

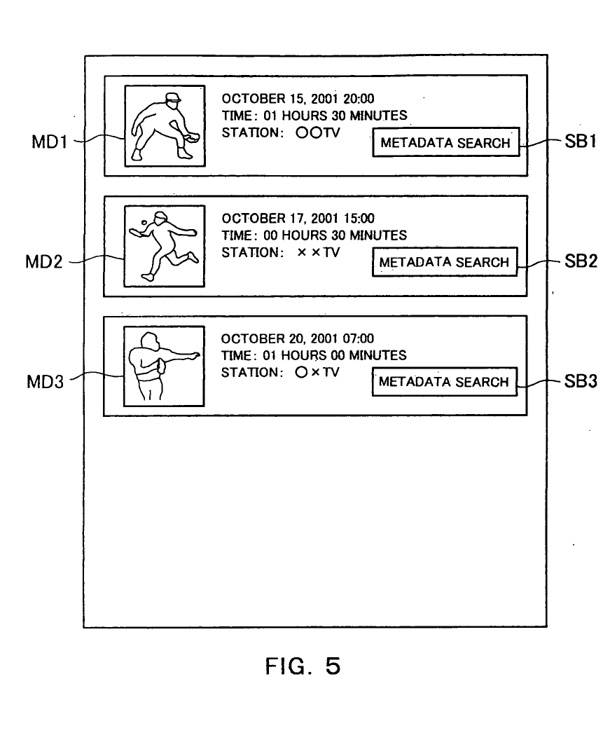

Referring to FIG. 6, an example of a search result display screen obtained by selecting one of the METADATA SEARCH buttons (SB1, SB2 or SB3) is shown. As shown, the search result display screen shows metadata associated with the baseball media data (MD1) shown in FIG. 5. A media data displaying portion 71 displays the contents of the media data (MD1) with a thumbnail icon, the broadcasting start year/date/time, the total broadcasting duration and the broadcasting station name. A media data time-line 72 indicates the amount of overlapping time of the media data with selected metadata found in the search. A metadata name displaying portion 73 displays the contents of the metadata search results. For instance, the metadata name displaying portion 73 may display “COMMENTARIES ARE ADDED TO EACH PLAY IN THE BASEBALL BROADCAST” to reflect a metadata search result of commentaries about each play in a baseball game broadcast on a certain day. A metadata time-line 74 indicates the amount of media data stored in the media data storing portion 15 that corresponds to search result metadata. Portions corresponding to existing media data are shown in white whereas portions not corresponding to existing media data are shown in black. Selecting a portion of the metadata time-line 74 changes the media data time-line 72 depending on the time data of the selected metadata. Also, depending on the metadata of the metadata time-line 74 on which the user places the pointer, the time overlapping portions will be indicated in white and the remaining portions will be indicated in black. Thus, only the portions for reproducing metadata will be indicated in white the remaining portions will be indicated in black.

As shown in FIG. 6, the searched metadata and the media data are compared to determine the degree that the time data conform with each other (herein “conformity degree”) . Metadata having a conformity degree of at least a certain threshold or more are preferably displayed in order of highest conformity degree. The conformity degree is expressed by how much the metadata total time overlaps with the media data total time based on the media data total time. The conformity degree is calculated using the time data of the metadata and the time of the media data. For instance, media data having a time data of “Oct. 15, 2001, Start time: 20:00, Total time: 1 hour 30 minutes, Broadcasting station: ** TV” and metadata having a time data of “Oct. 15, 2001, Start time: 20:10, Total time: 45 minutes, Broadcasting station: ** TV” have a time data overlap of 45 minutes. The remaining time data does not overlap. In this case, the conformity degree is calculated as 45 minutes of the time data overlap divided by 90 minutes of the media data total time (45/90=0.5). Obviously, the white portion of the media data time-line 72 is increased and the black portion of the media data time-line 72 is decreased where there is a high conformity degree.

A user selects metadata to be reproduced by selecting the appropriate metadata displaying portion 73 on the search result screen as shown in FIG. 6. Upon selection, the selected metadata is reproduced together with the corresponding media data stored in the media data storing portion 15. Preferably, the reproduction is performed in a state in which the media data and the metadata are synchronized with each other with respect to time. The synchronizing of the media data and the metadata is performed based on their respective time data. For instance, media data having a time data of “Oct. 15, 2001, Start time: 20:00, Total time: 45 minutes, Broadcasting station: ** TV” and metadata having a time data of “Oct. 15, 2001, Start time: 20:10, Total time: 45 minutes, Broadcasting station: ** TV,” are synchronized such that the metadata is displayed 10 minutes after the reproduction of the media data has been started.

The time data in metadata created in a media data audio-visual device (10-1, . . . , 10-n) is inserted based on an internal clock of the media data audio-visual device (10-1, . . . , 10-n) which may possibly be inaccurate. Accordingly, if the media data and the metadata are simply synchronized based on the time data in the metadata, the metadata display timing may possibly be incorrect. For instance, comments on a specific scene may be displayed during a scene other than the specific scene. To overcome this problem,-an initial coarse synchronization may be performed based on the time data and then a final fine synchronization may be performed based on the feature amount of an image in the media data.

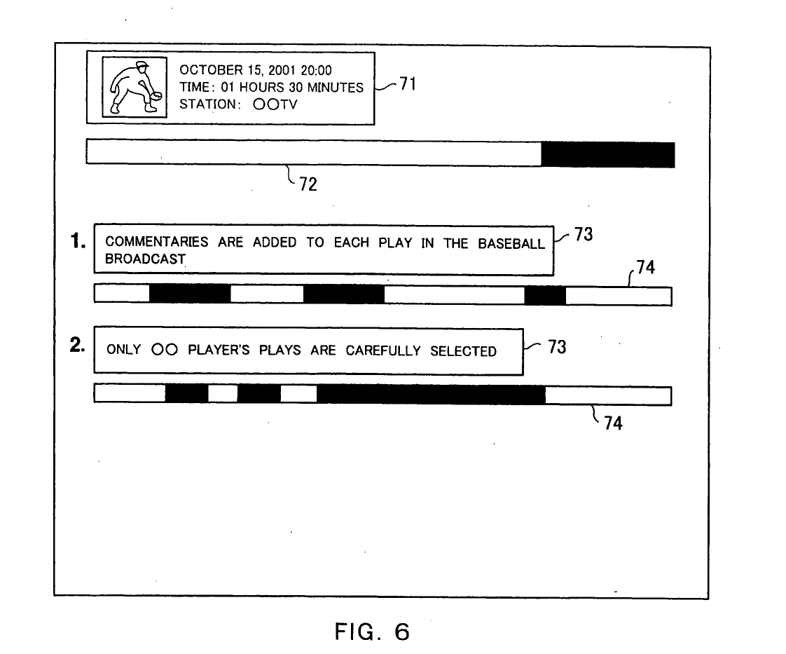

Referring to FIG. 7, a schematic illustration of a method for performing synchronization of media data and metadata is shown. First, a corresponding feature amount of an image occurring in the media data at the time that the metadata is being created (e.g., the still image itself, the contour information detected by edge detection, the brightness information, the corner image, etc.) is recorded in the metadata along with the metadata text. Next, after the initial coarse synchronization of the metadata and the media data based on the time data in the metadata, the feature amount recorded in the metadata is searched for in the media data at the vicinity of the initial synchronized position in the media data. The correct synchronized position of the media data is recognized as the position matching the feature amount as stored in the metadata. A shift in position may be necessary where the internal clock of the device used to create the metadata is different than the media data time clock. For instance, as shown in FIG. 7, the metadata is shifted from 8:10 PM of the media data to 8:11 PM of the media data so that the metadata comments will be displayed at the correct time of the media data reproduction.

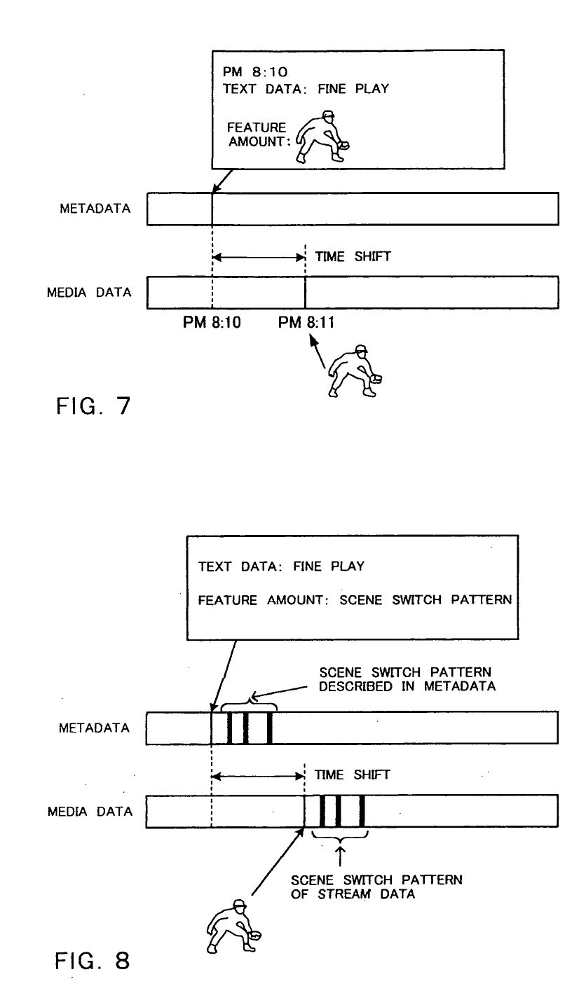

Referring to FIG. 8, a schematic illustration of another method for performing synchronization of media data and metadata is shown. In TV programs, scene switching occurs frequently and in unique patterns in accordance with the switching of camera angles. Accordingly, in this method, the scene switching pattern showing the time positions of scene switches is stored as the feature amount in the metadata. Next, after the initial coarse synchronization of the metadata and the media data based on the time data in the metadata, the scene switching pattern stored in the metadata is searched in the media data at the vicinity of the initial synchronized position. The correct synchronized position of the media data is recognized as the position matching the scene switching pattern feature amount as stored in the metadata.

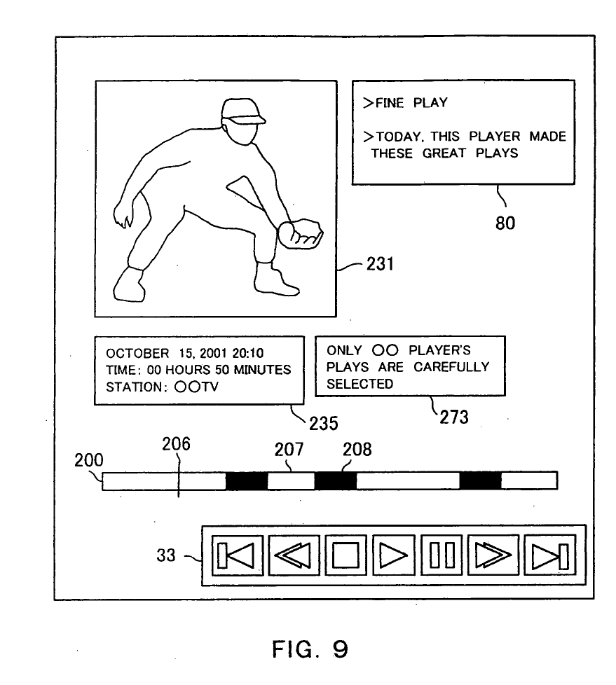

Referring to FIG. 9, an example of a display screen having media data and the obtained metadata are displayed simultaneously after synchronization is shown. A media data displaying portion 231 displays media data and a metadata content displaying portion 80 displays obtained associated metadata that is correctly synchronized with the media data being displayed. Further, a metadata name displaying portion 273 displays the contents of the metadata and a time data displaying portion 235 displays the time data attached to the media data. In this example, the media data displaying portion 231 displays only the portion of the media data that correspond to the obtained metadata. The portions of the media data that do not correspond to the metadata are not displayed. For instance, only the portions corresponding to those scenes related to a particular player are retrieved from the corresponding media data and only those retrieved portions are displayed on the media data displaying portion 231. A media data time-line 200 is used to indicate this relationship. The white portions 207 indicate that metadata exists. Only the media data corresponding to the white portions 207 will be reproduced. The media data corresponding to the black portions will be skipped. A bar 206 indicates the current reproducing position of the media data shown on the display portion 231.

Optionally, link information may be added to media data in metadata. For instance, an additional comment such as “Today, this player made these great plays” is displayed along with the comment “Fine play!” in the metadata content displaying portion 80. A hyperlink may be added to the additional comment such that selecting the additional comment enables the viewer to jump to another scene. Additionally, the link display can be prohibited or the link processing can be stopped where the user does not have the media data corresponding to the link destination stored in the audio-visual device (10-1, . . . , 10-n).

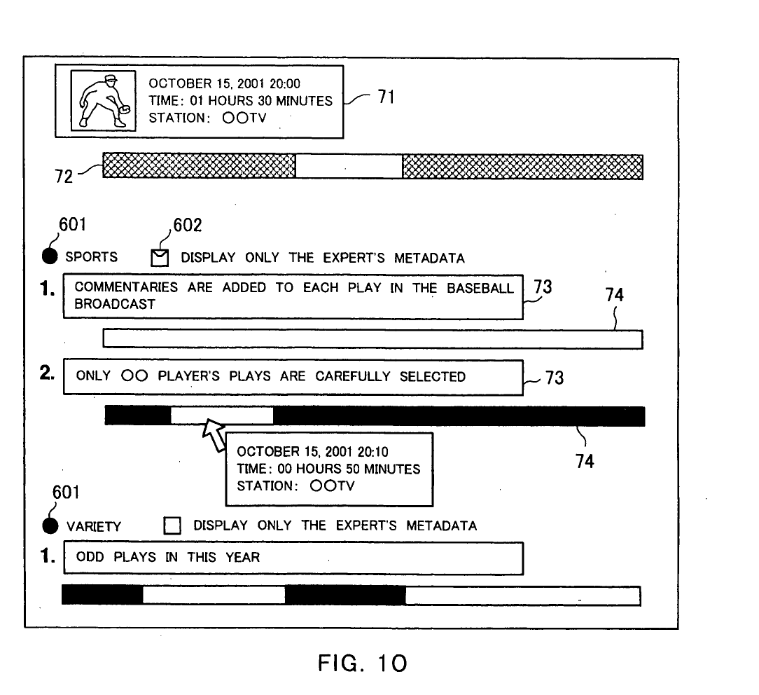

Referring to FIG. 10, another example of a metadata search result list screen is shown. This display screen has at least three features different from the display screen shown in FIG. 6. The first difference is the metadata search results are separated into genres and displayed according to its associated genre. For instance, the metadata search results are separated into a “SPORTS” genre and a “VARIETY” genre as indicated by reference numeral 601 in FIG. 10.

A second difference is that check boxes 602 may be selected to display only the metadata created by a popular or notable person (herein “expert”) among all other metadata creators. Selecting check box 602 causes the metadata search results created by the expert to be displayed. The data indicating who is an expert is given by the information processing portion 22 of the server 20 shown in FIG. 1B. Each time metadata is read from the metadata storing portion 23 and exchanged among the media data audio-visual devices (10-1, . . . , 10-n), the information processing portion 22 identifies the metadata creator using creator authentication data embedded in the metadata, and then increments expert degree data of the specified metadata creator. The expert degree data may be stored in the metadata storing portion 23. When the expert degree data reaches at least a predetermined value, the information processing portion 22 sets a flag representing the title of expert. An expert may also be determined based on the degree of attention to a particular metadata obtained by dividing the number of times the metadata is retrieved by the time period of the retrievals. The expert data also may also be classified into genres, such as drama, news and sports, and may be designated by different flags.

A third difference is where the obtained metadata is a combination of metadata associated with the media data subjected to the search and metadata of other media data, the corresponding relationship between the media data and the metadata is displayed by both the time-line 72 and the time-line 74. For instance, metadata obtained as a search result may include media data edited by selecting the scenes of the player's play from a number of games. In this case, the intersection of the media data associated with the metadata obtained in the search and the media data subjected to the search is only a part of the entire media data. Accordingly, as indicated by the time-line 74, only the portions corresponding to the media data stored in the media data storing portion 15 of the user's device are shown in white and the remaining portions are shown in black. Further, when a pointer, such as a mouse pointer, is placed over the white portion, the corresponding time data of the stored media data is displayed. Additionally, the portion of the time-line 72 corresponding to this white portion is indicated in white and the remaining portion is indicated in gray. Thus, it is possible to easily understand the relationship between the obtained metadata and the selected media data that is stored in the user's device.

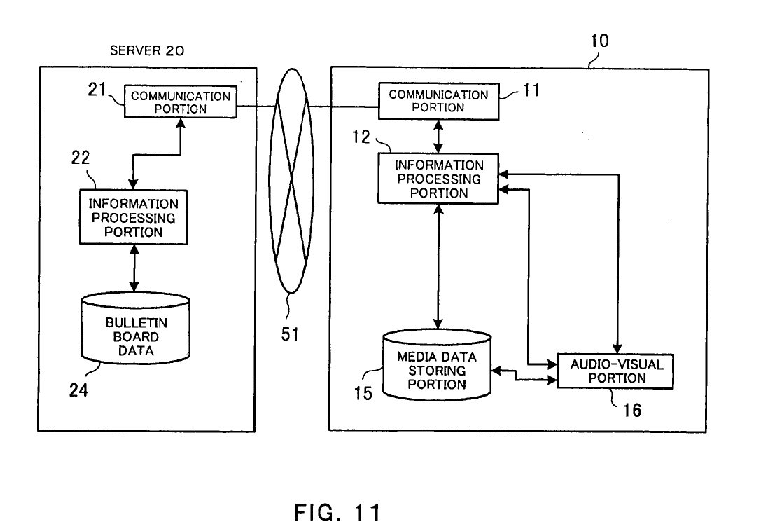

Next, an alternate embodiment of the present invention will be explained with reference to FIG. 11. In this alternate embodiment, a plurality of bulletin boards are provided for each media data (or each scene), and the bulletin board data is searched and/or retrieved and combined with media data so that the bulletin board data can be read. The written contents or messages on the bulletin boards are stored in the bulletin board data storing portion 24 provided in the server 20. The message data written to each bulletin board are arranged in order of the time flow of the associated media data. For example, where the media data of the baseball game broadcast of “G Team” vs. “T Team” held on a certain date is stored in the media data storing portion 15, the bulletin board is searched in storing portion 24 and the corresponding messages are displayed on the audio-visual portion 16 in accordance with the progress of the baseball game.

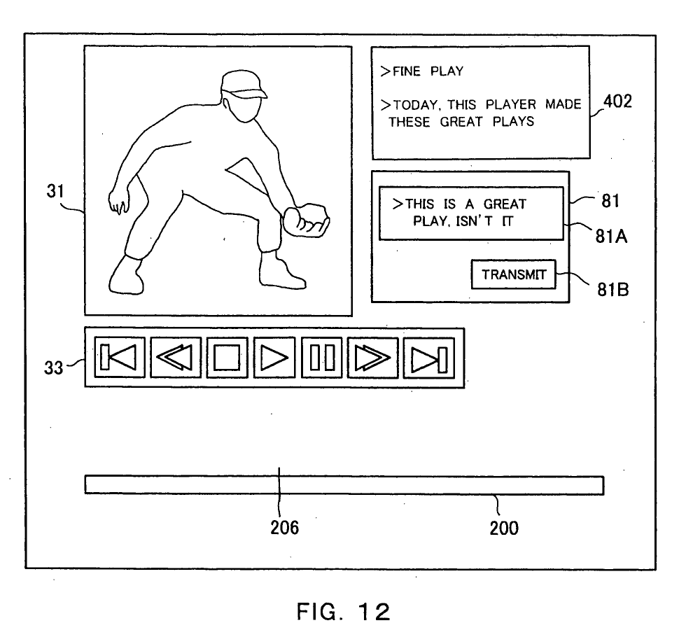

Referring to FIG. 12, an example of an audio-visual device screen showing matched media data and bulletin board data as metadata is shown. Bulletin board messages are displayed in sequence on the media data content displaying portion 402 in accordance with the time flow of the media data. Further, a viewer can write messages to the bulletin board while viewing retrieved messages. Selecting the TRANSMIT button 81B, after inputting messages in the message writing window 81A of the message input portion 81, matches the message data with the time data of the media data which was being displayed on the display portion 31 and then writes the message information on a bulletin board corresponding to the time data among a plurality of bulletin boards. For instance, a separate bulletin board may be established for each scene. Thus, when bulletin boards are prepared for each scene of the media data as mentioned above, a bulletin board corresponding to the time data can be automatically selected. It is also possible to allow a viewer to select a bulletin board to which the viewer wishes to post a message.

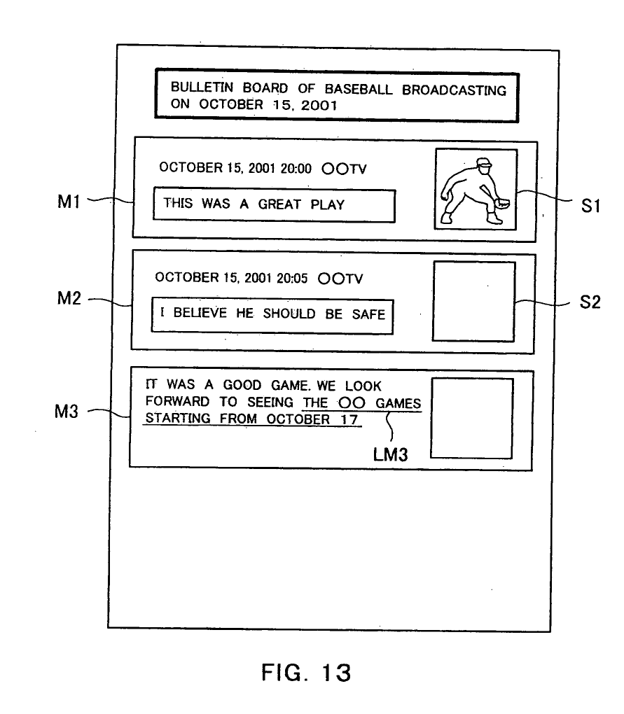

FIG. 13 shows another embodiment of a bulletin board display. As shown in FIG. 13, messages (M1, M2 and M3) are displayed together with the time data and the thumbnail icons (S1 and S2). The display can be arranged in the order that the messages were posted or in the media data time flow order. Selecting one of the displayed messages (M1, M2 and M3) with a selection tool, such as a mouse, retrieves the corresponding media data from the media data storing portion 15 and reproduced the corresponding media data. The bulletin board messages may then be displayed in sequence in accordance with the time flow of the media data as it is being reproduced, in the same manner as previously described in FIG. 12. Additional features, such as Frequently Asked Questions (FAQs) contained in bulletin board data may optionally be displayed on the media data display portion 31.

Additionally, the contents of the bulletin board may optionally be searched. For instance, a search request using a term as a keyword may be transmitted for the purpose of searching messages within the bulletin board where a user cannot understand the meaning of the term used in media data. The search request may be transmitted together with the time data regarding the appearance of the unknown term. For instance, a range of within ±5 minutes of the time in the time data may be specified.

The information processing portion 12 may optionally be configured to reserve the recording of a certain program based on information regarding future broadcasting programs contained in the messages on the bulletin board. For instance, as shown in FIG. 13, the comments “we look forward to seeing the ** games starting from Oct. 17” contained in the message (M3) may be linked to the broadcasting time data of the “** game starting from Oct. 17” such that the broadcasting time data is automatically downloaded from the server 20 when the comments are selected. The information processing portion 12 sets up a recording reservation for the program based on the downloaded broadcast time data.

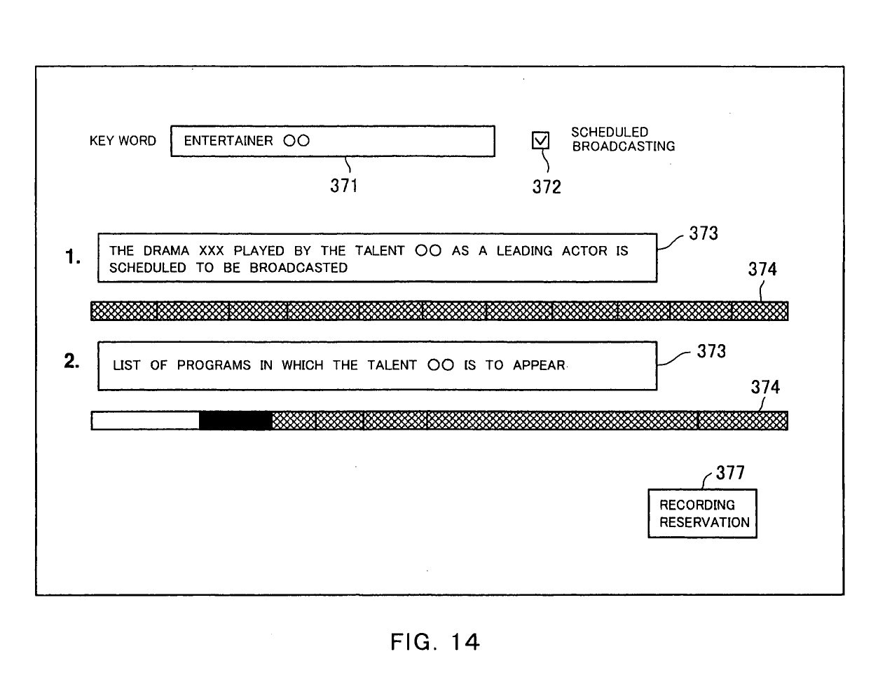

Next, another alternate embodiment of the present invention will be explained with reference to FIG. 14. In this alternate embodiment, metadata associated with media data that will be broadcasted in the future is searched and displayed. Metadata associated with media data to be broadcast in the future is preferentially searched by transmitting a search request after inputting a search character string in a keyword input window 371 and selecting the SCHEDULED BROADCASTING check box 372. The contents of the search result metadata are displayed in a metadata name displaying portion 373. Time-lines 374 is shaded to indicate whether the media data corresponding to the metadata as search results is scheduled to be broadcasted at a future time (gray), already broadcasted and stored in the media data storing portion 15 (white), or already broadcasted but not stored in the media data storing portion 15 (black).

A user may set a recording reservation to record the broadcasting of a program by selecting the metadata name displaying portion 373 and then selecting the RECORDING RESERVATION icon 377. The information processing portion 12 sets up the recording reservation accordingly. Thus, setting a recording reservation for programs to be broadcast in the future (as shown in gray) can be performed by a single operation. For instance, selecting the metadata name displaying portion 373 corresponding to “The drama entitled XXX played by the talent ** as a leading actor is scheduled to be broadcasted”, and then selecting the recording reservation icon 377 results in a recording reservation of all 11 drama programs using a single operation. Even if the broadcasting of the first episode and the final episode are extended by 30 minutes or the broadcasting time of each episode differs because of late night broadcasting programs, the recording reservation can be performed by a single operation because the metadata includes the broadcasting time data of each drama.

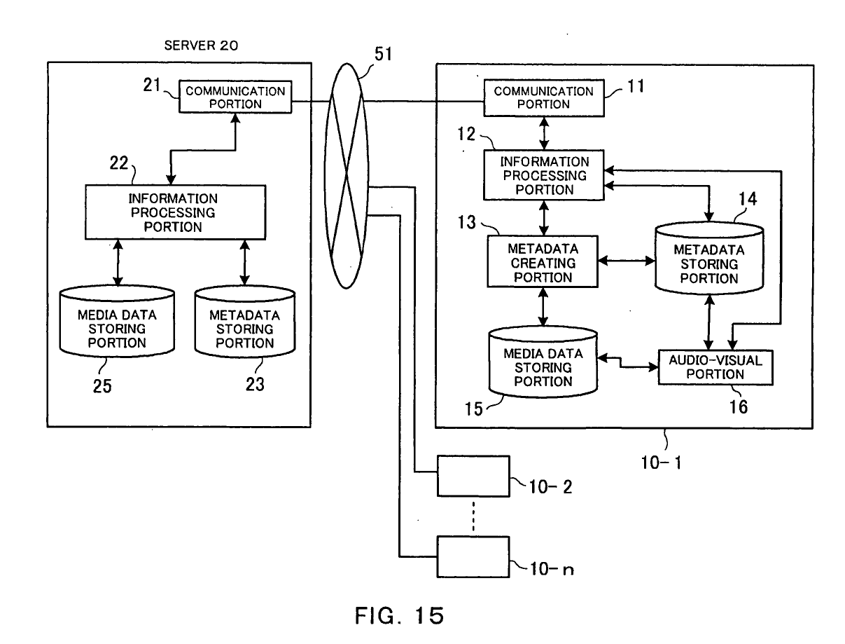

Next, yet another alternate embodiment of the present invention will be explained with reference to FIG. 15. In the previous embodiment, the server 20 contains only a metadata storing portion 23 and thus provides only metadata from the metadata storing portion 23. According to this alternate embodiment, the server 20 also includes a media data storing portion 25, and thus the server 20 also provides media data from the media data storing portion 25. The media data stored in the media data storing portion 25 is scrambled or encoded by scrambling signals such that the media data cannot be reproduced simply by reading out the data from the storing portion. The decoding information for decoding the scrambled media data is embedded in the metadata stored in the metadata storing portion 23. The information processing portion 12 of each media data audio-visual device (10-1, . . . , 10-n) is provided with software for descrambling the scrambled media data that is downloaded from the media data storing portion 25, based on the decoding information embedded in the metadata. Thus, a user of the media audio-visual data device (10-1, . . . , 10-n) may view the media data by downloading both the media data and the metadata as a set to remove the scrambling of the media data in the information processing portion 12.

With this structure, it becomes possible to have each viewer see an advertisement in return for the free offering of the media data by adding a current advertisement to the metadata that contains the descrambling code. Such an advertisement can be Telop characters, such as a video caption, displayed in the corner of the screen or a spot commercial video inserted between the media data.

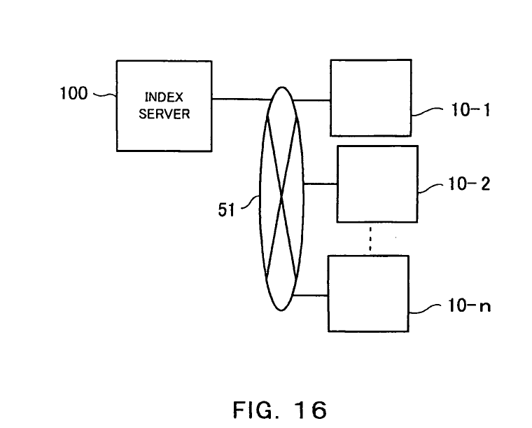

Although various embodiments of the present invention were explained above, the present invention is not limited to the above. For example, instead of having a server 20 store metadata created in each media data audio-visual device (10-1, . . . , 10-n) to be transmitted to other media data audio-visual devices, a Peer-to-Peer system may be employed as shown in FIG. 16. In detail, an index server 100 simply administrates the network address of each media data audio-visual device (10-1, . . . , 10-n), and the exchanging of metadata and other data is performed directly among the media data audio-visual devices (10-1, . . . , 10-n). For searching metadata, a search request is broadcasted from one of the media data audio-visual devices (10-1, . . . , 10-n) to the other media data audio-visual devices (10-1, . . . , 10-n). In response to the search request, a media data audio-visual device (10-1, . . . ,10-n) having the requested metadata transmits the requested metadata to the requesting media data audio-visual device (10-1, . . . , 10-n). Thus, the requested metadata may be searched from among all of the audio-visual devices on the network.

Alternatively, the index server 100 may store index data showing which media data audio-visual device (10-1, . . . , 10-n) has which media data. In this case, a media data audio-visual device (10-1, . . . , 10-n) requesting a search transmits a search request to the index server 100. The index server 100 then returns the address information of the media data audio-visual device(s) (10-1, . . . , 10-n) having the requested search metadata to the requesting audio-visual device (10-1, . . . , 10-n). The requesting media data audio-visual device (10-1, . . . , 10-n) receiving the return address information then directly accesses the media data audio-visual device having the requested search metadata based on the address information, to download the metadata.

As mentioned above, according to the media data audio-visual device of the present invention, metadata created by each viewer is disclosed to other devices and the disclosed metadata can be owned jointly by a number of viewers.

Also, as previously mentioned, metadata created by each viewer is disclosed to other devices and the disclosed metadata can be owned jointly by a number of viewers.

1. A media data audio-visual device for viewing media data, comprising:
an audio-visual portion configured to display the media data;
a metadata storing portion configured to store metadata corresponding to the media data;
a communication portion configured to transmit the metadata externally and receive external metadata to be stored in the metadata storing portion; and
a display portion configured to display a time relationship between selected media data and selected metadata based on time data embedded in the media data and in the metadata.

2. The media data audio-visual device according to claim 1, further comprising a metadata creating portion configured to enable a user to create metadata.

3. The media data audio-visual device according to claim 2, wherein the metadata creating portion includes a disclosure selection tool configured to enable a user to designate whether created metadata is to be disclosed externally.

4. The media data audio-visual device according to claim 1, further comprising a search condition inputting portion configured to enable a user to input search conditions for searching the external metadata.

5. The media data audio-visual device according to claim 1, further comprising a synchronizing portion configured to extract characteristic data that is stored in the metadata, search for corresponding characteristic data in associated media data, and to synchronize the metadata with the associated media data to correct any time differences between the metadata and the media data caused by inaccurate time data in the metadata.

6. The media data audio-visual device according to claim 5, wherein the audio-visual portion displays the metadata and the media data with corrected timing corrected by the synchronizing portion.

7. A metadata sharing system, comprising:
a plurality of client media data audio-visual devices each configured to display media data and metadata corresponding to the media data; and
a server configured to exchange data among the plurality of client media data audio-visual devices,
wherein each of the plurality of client media data audio-visual devices includes:
an audio-visual portion configured to display the media data;
a metadata storing portion configured to store the metadata;
a communication portion configured to transmit the metadata to the server and to receive metadata from the server to be stored in the metadata storing portion; and
a display portion configured to display a time relationship between the media data and the metadata based on time data included in the metadata and in the media data,
wherein the server includes a metadata storing portion configured to store the metadata transmitted from the plurality of client media data audio-visual devices.

8. The metadata sharing system according to claim 7, wherein the metadata creating portion includes a disclosure selection tool configured to enable a user to designate whether created metadata is to be disclosed externally.

9. The metadata sharing system according to claim 7, wherein each of the plurality of client media data audio-visual devices includes a metadata creating portion configured to enable a user to create the metadata.

10. The metadata sharing system according to claim 7, wherein each of the plurality of client media data audio-visual devices includes a search request inputting portion configured to enable a user to input a search request for searching the metadata stored in the server, and wherein the server includes a metadata searching portion configured to search for the metadata in the metadata storing portion that corresponds to the search request.

11. The metadata sharing system according to claim 10, wherein the server is configured to transmit search results from the metadata searching portion to a requesting media data audio-visual device of the plurality of client media data audio-visual devices such that a desired metadata from the search results is selected by a user.

12. The metadata sharing system according to claim 10, further comprising a user input interface configured to input a search request by a user for searching metadata corresponding to media data scheduled to be broadcast at a future time, and wherein each of the plurality of client media data audio-visual devices is configured to set a recording reservation to record the media data scheduled to be broadcast using search results from the metadata searching portion.

13. The metadata sharing system according to claim 10, wherein the server includes a metadata creator data storing portion configured to store metadata creator data identifying a creator of specific metadata and incrementing a value associated with the metadata creator data each time the specific metadata is exchanged among the plurality of client media data audio-visual devices, and wherein metadata creator data is added to the search request of the search request inputting portion.

14. The metadata sharing system according to claim 13, wherein the metadata creator data is obtained using creator authentication data included in the metadata.

15. A metadata sharing system, comprising:
a plurality of client media data audio-visual devices each configured to display media data and metadata; and
a server configured to exchange data among the plurality of client media data audio-visual devices,
wherein each of the plurality of client media data audio-visual devices includes:
an audio-visual portion configured to display the media data;
a metadata creating portion configured to enable a user to create metadata corresponding to the media data;
a metadata storing portion configured to store the metadata; and
a communication portion configured to transmit the metadata created by the metadata creating portion to the server and to receive metadata from the server to be stored in the metadata storing portion,
wherein the server includes a metadata storing portion configured to store the metadata transmitted from each of the plurality of client media data audio-visual devices and a bulletin board configured such that created messages are posted by the plurality of client media data audio-visual devices,
wherein the metadata creating portion is configured to associate created messages with a specified position in corresponding media data, and
wherein the communication portion is configured to transmit the created messages to the server and the created messages are written to a bulletin board corresponding to the specified position.

16. The metadata sharing system according to claim 15, wherein the media data includes a plurality of portions, and wherein the server includes a bulletin board for each of the plurality of portions of the media data or a specific portion of at least one of the plurality of portions of the media data, the server being configured to determine an appropriate bulletin board from the specified position of one of the created messages and to write the one of the created messages to the appropriate bulletin board.

17. The metadata sharing system according to claim 15, wherein each of the plurality of client media data audio-visual devices is configured to set up a recording reservation for recording a program broadcast utilizing scheduled broadcasting data of the broadcasting program contained in a created message retrieved from the bulletin board.

18. A metadata sharing system, comprising:
a plurality of client media data audio-visual devices each configured to display media data and metadata; and
a server configured to exchange data among the plurality of client media data audio-visual devices,
wherein the server includes scrambled media data and associated metadata containing descrambling information for the scrambled media data to allow the scrambled media data to be viewed on at least one of the plurality of client media data audio-visual devices,
wherein each of the plurality of client media data audio-visual devices includes:
an audio-visual portion configured to display media data;
a metadata creating portion configured to enable a user to create metadata corresponding to specific media data;
a metadata storing portion configured to store metadata;
a communication portion configured to transmit metadata created by the metadata creating portion to the server and to receive the media data and the metadata from the server; and
a descrambling portion configured to descramble the scrambled media data received from the server using the descrambling information contained in the metadata received from the server.

19. The metadata sharing system according to claim 18, wherein the metadata containing descrambling information also includes advertisement data to be displayed with the descrambled media data on a recipient of the plurality of client media data audio-visual devices.
